(19) United States
(12) Patent Application Publication
(10) Pub. No.: US 2002/0169743 A1
(43) Pub. Date: Nov. 14, 2002

(54) Web-based method and system for identifying and searching patents

(76) Inventors: David Arnold, Chester, CT (US); Dave Scot Christensen, Harwinton, CT (US); Carl Blaine Horton, Southington, CT (US)

Correspondence Address: PATENT OPERATION, GENERAL ELECTRIC COMPANY, 41 WOODFORD AVENUE, PLAINVILLE, CT, 06062

(21) Appl. No.: 09/681,613

(22) Filed: May 8, 2001

(51) Int. Cl. G06F 7/00

(52) U.S. Cl. 707/1

(57) ABSTRACT

A web-based method of obtaining recorded information based on a pre-defined search criteria includes the steps of receiving search criteria from a user through pull down menus, accessing a centralized database of recorded information, wherein the recorded information is linked to at least one identifier such as an identifier number, and comparing the search criteria with information in the database using identifiers to retrieve the requested information. Boolean logic operators are used to define logical relationships among various search criteria to conduct a more focused search and scheduled searching is used to provide updates of recently published recorded information.

This application is a continuation-in-part of U.S. patent application Ser. No. 09/670,631, filed Sep. 9, 2000. A portion of the disclosure of this patent document contains material which is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### BACKGROUND OF INVENTION

This invention relates generally to computer network-based systems and more particularly to a network-based method for automatically and periodically identifying and searching patents relating to specific business groups within a business entity.

Some information is publicly available through the collections of computer networks known as the Internet and World Wide Web. For example, searchable technology databases provide substantial accessibility to the user via the World Wide Web. However, these accessible databases do not provide sufficient guidance on searching for specific information. To get to the basic information, the user has to communicate with several individuals within a business entity, which may become cumbersome and frustrating. Identifying a person within an organization to provide simple information sometimes is a significant challenge especially if the business entity is multi-national and has numerous businesses spread worldwide. The accessible databases also do not provide an automated procedure for providing patent related information on a regular basis, such as when a new patent is issued. To obtain such information on a regular basis, the user must repeatedly request the desired information.

It would therefore be desirable to provide a method for rapidly and conveniently accessing information on patents within the business entity. It would be further desirable to provide a method which links database information to a specific patent and provides quick retrieval and accessibility of data based on specific criteria. It would be even further desirable to have an automated database information retrieval process whereby the user places one request and gets repeated updates regarding newly issued patents on a regular basis.

### SUMMARY OF INVENTION

In an exemplary embodiment, a web-based method for determining patent information on newly issued patents includes accessing a centralized database which stores patent related information for each patent in one of several categories. For example, the database stores patent information by patent number, a brief description of the patent, relevant business technology or technologies where the issued patent has relevance, a name of the assignee or assignees as appropriate, an International Patent Classification (IPC) code as it relates to each patent, technology key words describing the patented technology, abstract, and other pertinent information relating to each patent number, such as, for example, US patent classification code or Derwent™ classification code. Each patent number is assigned a unique identifier and cross references relevant information relating to each patent. Based on the pre-selected search form, the user submits the information to the system for retrieval. In one embodiment, Boolean logic operators are used in a search request to define the relationship between various criteria and to obtain more focused and narrowed search results. The user defines the frequency at which successive searches of the database are to be conducted for a given search strategy, and the results are stored in a specified location, such as for example an electronic results-folder structure. The results-folder structure includes a delta-set folder and an accumulation-set folder. Upon retrieving recorded information that matches the search request criteria, the recorded information is saved to the delta-set folder. On successive searches, the contents of the delta-set folder are transferred to an accumulation-set folder and the delta-set folder is repopulated with the search results of the most recent database search. Thus, the delta-set folder retains only the most recent set of search results, and the accumulation-set folder contains an aggregate of all the delta-set results since the initiation of the respective database search process. The user is notified when the contents of the delta-set have been updated, and is provided with access to the delta-set and accumulation-set folders for viewing the search results. The utilization of two types of delta-set and accumulation-set folders provides for the retention of business-specific and project-specific search results.

While reference is made to “patents” generally, the term “patents” is intended to include both issued patents and published patent applications.

### BRIEF DESCRIPTION OF DRAWINGS

FIG. 1 is a simplified block diagram of a Patent Search Management System (PSMS) in accordance with one embodiment of the present invention;

FIG. 2 is an expanded version block diagram of exemplary architecture of a server system of the PSMS;

FIG. 3 shows a database configuration within a database server of the server system shown in FIG. 1;

FIG. 4 is an expert database configuration within a database server of the server system shown in FIG. 1;

FIG. 5 is an exemplary embodiment of a flow diagram of the web-based method for obtaining patent information based on a pre-defined search criteria with pull down menus;

FIG. 6 is an exemplary embodiment of a pre-defined generic patent search request form;

FIG. 7 is an exemplary embodiment of business-specific patent search request form;

FIG. 8 is an exemplary embodiment of a project-specific patent search request form;

FIG. 9 is an exemplary embodiment of a Boolean Logic Search Process as utilized by the PSMS shown in FIG. 1;

FIG. 10 is an exemplary embodiment of a results-folder structure for retaining the downloaded records that match the requestor's query;

FIG. 11 is an exemplary embodiment of a results notification for providing a requestor with notice of completed search; and

FIG. 12 is an alternative embodiment of a web-based method for obtaining patent information utilizing research service.

### DETAILED DESCRIPTION

Exemplary embodiments of systems and processes that facilitate integrated network-based electronic reporting and workflow process management related to Patent Search Management System (PSMS) are described below in detail. For example, the systems and processes facilitate electronic submission of client information using an automated extraction system, and web-based reporting of patents for internal system users.

The systems and processes are not limited to the specific embodiments described herein. In addition, components of each system and each process can be practiced independently and separately from other components and processes described herein. Each component and process also can be used in combination with other components and processes.

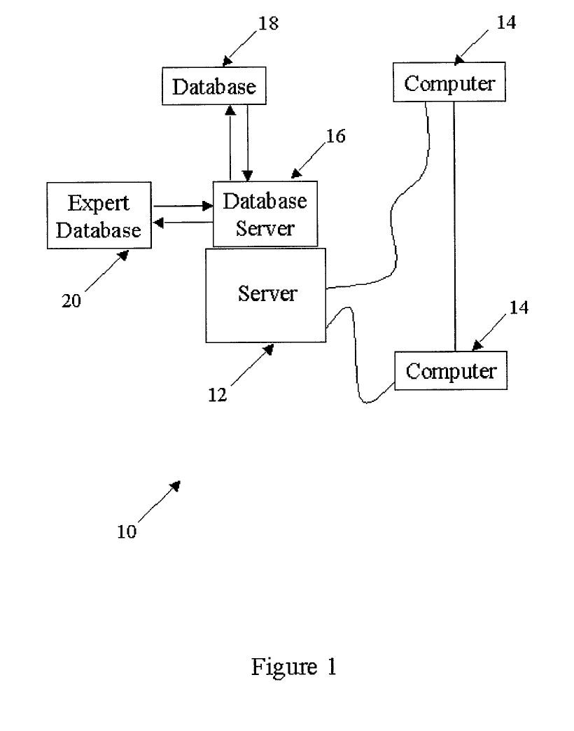

FIG. 1 is a simplified block diagram of a Patent Search Management System (PSMS) 10 including a server system 12 and a plurality of client systems 14 connected to server system 12. In one embodiment, client systems 14 are computers including a web browser, and server system 12 is accessible to client systems 14 via the Internet. Client systems 14 are interconnected to the Internet through many interfaces including, but not limited to, a network, such as a local area network (LAN) or a wide area network (WAN), dial-in-connections, cable, optical, infrared, radio frequency and microwave communications, special high-speed ISDN lines, and wireless or satellite communication media. Client systems 14 could be any device capable of interconnecting to the Internet including a computer, portable computing device, such as for example a PDA, web-based phone or other web-based connectable equipment. A database server 16 is connected to a centralized database 18 containing product or technology related information on a variety of products or technologies, as described below in greater detail. An expert database 20 is preferably located on database server 16. The database server 16 is stored on server system 12 and can be accessed by potential users by logging onto server system 12 through one of client systems 14.

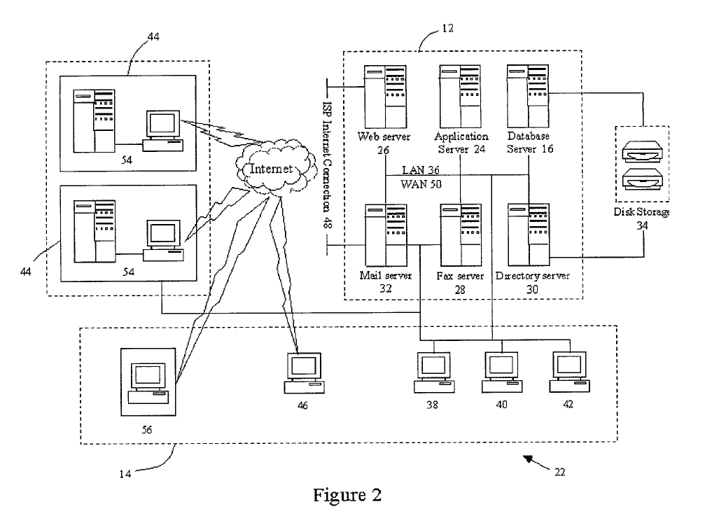

FIG. 2 is an expanded version block diagram of exemplary architecture of a server system of a Patent Search Management System (PSMS) 22. Components in system 22 identical to components of system 10 (shown in FIG. 1) are identified in FIG. 2 using the same reference numerals as used in FIG. 1. System 22 includes a server system 12 and client system 14. Server system 12 further includes a database server 16, an application server 24, a web server 26, a fax server 28, a directory server 30, and a mail, or email, server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an Intranet. In one embodiment, disk storage unit 34 is external to server system 12, as shown. In an alternate embodiment, disk storage unit 34 is internal to server system 12, not shown.

Each workstation, 38, 40, and 42 is a personal computer, or the functional equivalent, including a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server system 12 is configured to be communicatively coupled to various individuals or employees 44 and to third parties, e.g., internal or external auditors 46, via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, a local area network could be used in place of the WAN.

In the exemplary embodiment, any authorized individual or an employee of the business entity having a workstation 54 can access PSMS 22. One of the client systems 14 includes a senior manager's workstation 56 located at a remote location. Workstations 54 and 56 are personal computers including a web browser (not shown). Also, workstations 54 and 56 are configured to communicate with server system 12. Furthermore, fax server 28, via a telephone link, communicates with employees 44 located outside the business entity and with any of the remotely located client systems including a client system 56. Fax server 28 is configured to communicate with other client systems 38, 40, and 42 as well.

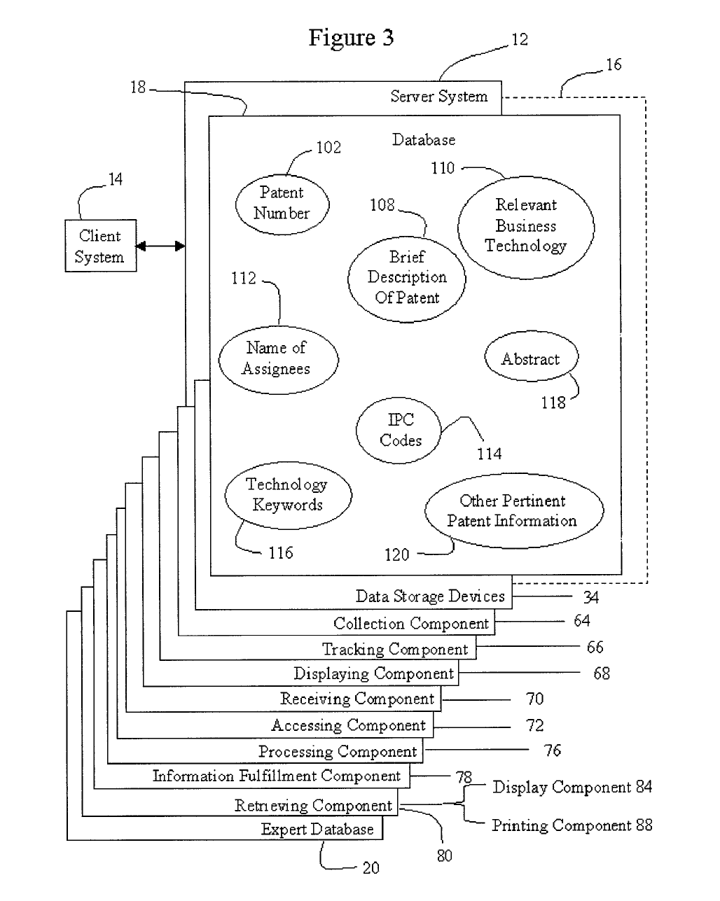

FIG. 3 shows a configuration of database 18 (shown in FIG. 1) within database server 16 (shown in FIG. 1) of server system 12 (shown in FIG. 1). Database 18 is coupled to several separate components within server system 12, which perform specific tasks.

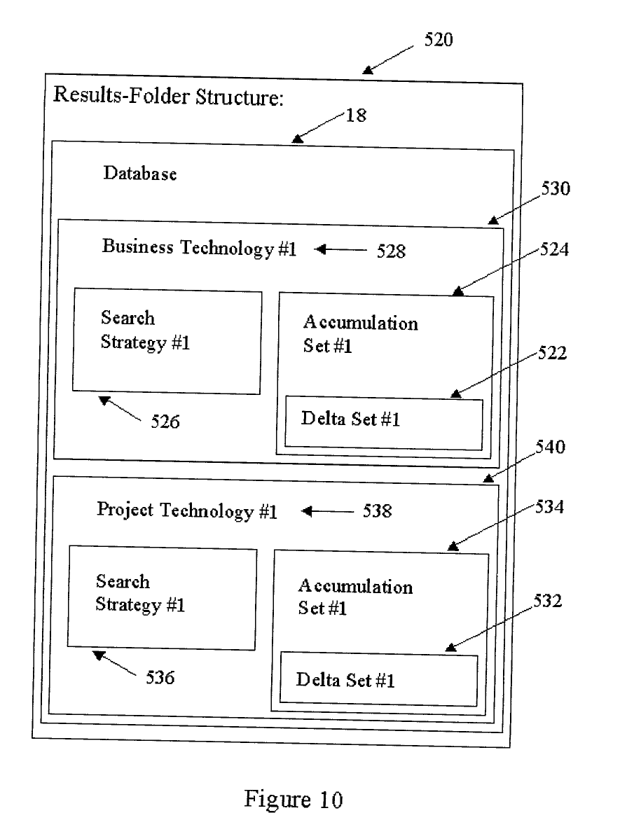

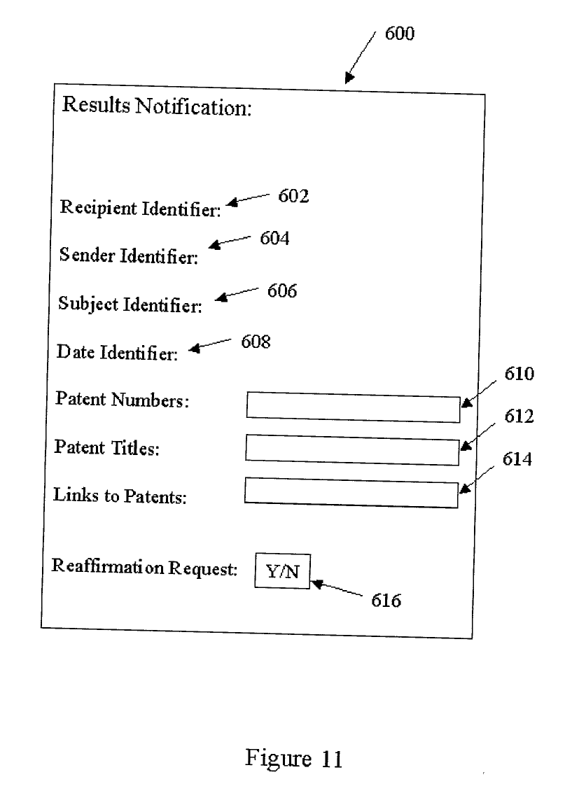

Server system 12 includes a collection component 64 for collecting information from users into centralized database 18, a tracking component 66 for tracking information, a displaying component 68 to display information, a receiving component 70 to receive a specific query from client system 14, and an accessing component 72 to access centralized database 18 residing on disk storage unit 34. Receiving component 70 is programmed for receiving a specific query from one of a plurality of users. The specific query from a user may be a business-specific query or a project-specific query, as described below. Server system 12 further includes a processing component 76 for searching and processing received queries against disk storage unit 34 containing a variety of information collected by collection component 64. Processing component 76 accesses expert database 20 for retrieval of user-defined information. An information fulfillment component 78, located in server system 12, downloads the requested information to a results-folder structure, as shown in FIG. 10, and provides results notification, as shown in FIG. 11, to the plurality of users preferably in the order in which the requests were received by receiving component 70, or according to a user-defined schedule as received by receiving component 70. Information fulfillment component 78 downloads the information after the information is retrieved from disk storage unit 34 by a retrieving component 80. Retrieving component 80 retrieves, downloads and sends information to client system 14 based on a query received from client system 14 regarding various alternatives.

Retrieving component 80 further includes a display component 84 configured to download information to be displayed on a client system's graphical user interface (not shown) and a printing component 88 configured to print information. Retrieving component 80 generates many types of various reports requested by the user through client system 14 in a pre-determined format. System 10 is flexible to provide alternative types of reports and is not constrained to the options set forth above. One embodiment of a report that may be displayed on display component 84 or printed on printing component 88 is illustrated by results notification 600 shown in FIG. 11.

Database 18, which stores patent related information, stores information for each patent in one of several categories. For example, database 18 stores patent information by a patent number 102, a brief description of the patent 108, relevant business technology or technologies 110 where the issued patent has relevance, a name of the assignee or assignees 112 as appropriate, an International Patent Classification (IPC) code 114 as it relates to each patent, technology key words 116 describing the patented technology, abstract 118, and other pertinent information 120 relating to each patent number 102. Patent number 102 is assigned a unique identifier and each patent number cross references relevant information relating to each patent.

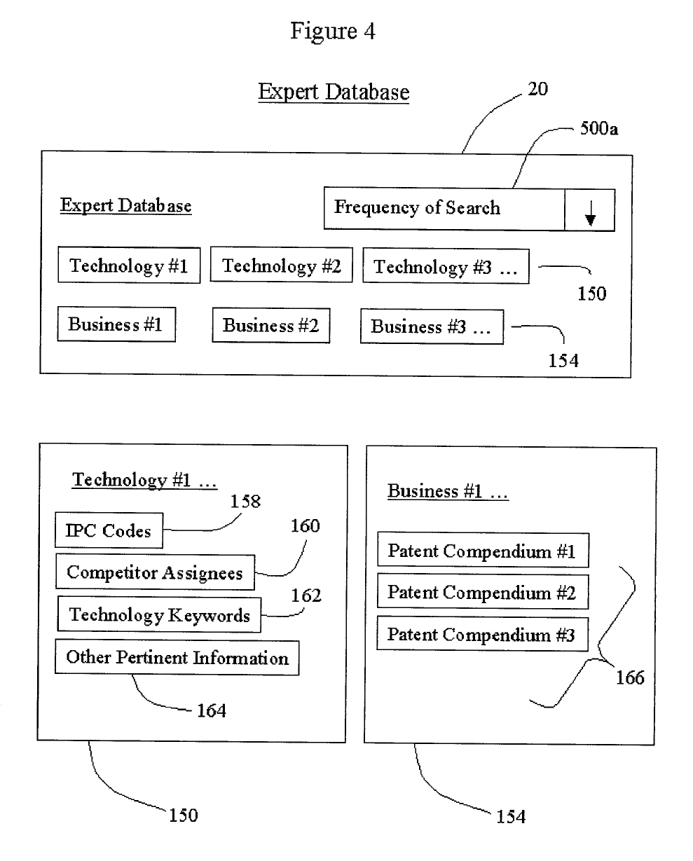

FIG. 4 shows a configuration of expert database 20 (shown in FIGS. 1 and 3) within database server 16 (shown in FIG. 1) of server system 12 (shown in FIG. 1). Database 20 is comprised of several folders, each including specific data relating to a particular technology 150 and/or a business 154. Within technology folders 150 are a Boolean listing of IPC Codes 158 that relate to that particular technology, a Boolean listing of Competitor Assignees 160 that have patents or products in that particular technology, a Boolean listing of Technology Keywords 162 that further describe that particular technology, and Other Pertinent Information 164 that may serve to further define the patent search domain. Within business folders 154 are patent compendiums 166 that contain a Boolean listing of patents relevant to a particular product or technology within that particular business. The pre-defined Boolean listings are created by one or more business experts and are an important part of the present invention as they serve to appropriately tailor the search strategy for a particular technology within a particular business. By utilizing such an expert system, many individuals can benefit from the knowledge of a few experts.

The architecture of system 10 as well as various components of system 10 are exemplary only. Other architectures are possible and can be utilized in connection with practicing the processes described below.

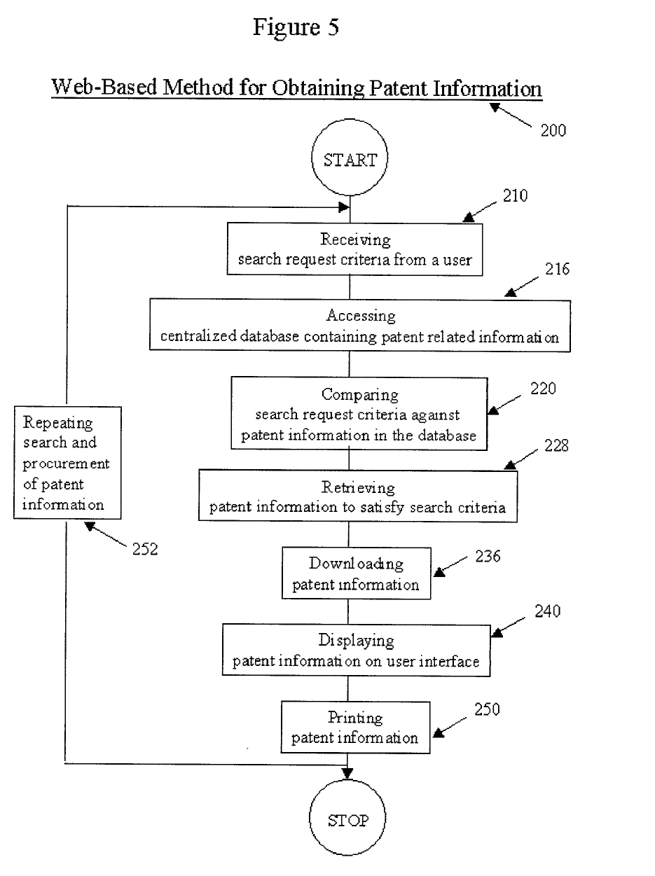

FIG. 5 is a flow diagram 200 for a web-based method of obtaining patent information based on pre-defined or user-defined search criteria with, for example, optional pull down menus. In another embodiment, search criteria may be supplied through a voice activated device rather than submitting search criteria through pull down menus. The web-based method includes the steps of receiving 210 search request criteria from a user, accessing 216 a centralized database of patent information including identifiers associated with each patent, comparing 220 the search request criteria against the patent information maintained in the centralized database using the identifiers, retrieving 228 the patent information to satisfy the search criteria, and finally downloading 236 the patent information to a results-folder structure 520, described below in conjunction with FIG. 10, and the user, described below in conjunction with results notification 600 in FIG. 11. In another embodiment of the invention, the web-based method 200 includes an additional step of repeating 252 the search and procurement of patent information, whereby the step of receiving 210 search request criteria from a user is automated, such that the search request criteria, described infra, is accessed by or received by the PSMS 10 at pre-defined intervals, such as for example once a month, week, or day. Instead of the user periodically submitting the same set of search request criteria on form 270, 270a, 270b, the PSMS 10 saves the search request criteria from the user's first submission via form 270, 270a, 270b, and then periodically and automatically receives the same search request criteria at pre-defined intervals of time. One example of the saved search request criteria is illustrated by 526, 536 in FIG. 10. In one embodiment, the PSMS 10 initiates an action to access the saved search request criteria from database 18 on a periodic basis (data “pull”), and in an alternate embodiment, the PSMS 10 is programmed to have the saved search request criteria automatically and periodically submitted to the PSMS 10 at pre-defined intervals of time (data “push”). The step of receiving 210 search request criteria from a user is intended to encompass both data “pull” and data “push” embodiments, and any equivalent embodiment that provides the same end result of periodic and automated searching.

In another embodiment of the invention, flow diagram 200 involves displaying 240 patent information on a graphical user interface and subsequently printing 250 the patent information. Printed or downloaded results are categorized according to relevant businesses or projects associated with the business entity or any other method of categorization such as categorization by title, abstract, short description, inventor name, assignee, and the relevance of patent claims as related to the search criteria.

In another embodiment of the invention, receiving 210 search request criteria from a user further involves defining a logical relationship among search terms, often referred to as Boolean Logic. Search terms that may be involved are: an IPC Code, Technology Keywords, Competitor Assignees, a Patent Number, a Name of the business, and an Inventor name. These search terms are also used for accessing 216, comparing 220, retrieving 228, and downloading 236 pertinent patent information from centralized database 18.

In yet another embodiment of the invention, method 200 and system 10 are protected to avoid unauthorized access and also to ensure that system 10 only receives 210 the request from the user after the user has been authenticated by server system 12 and given authorized access to the PSMS.

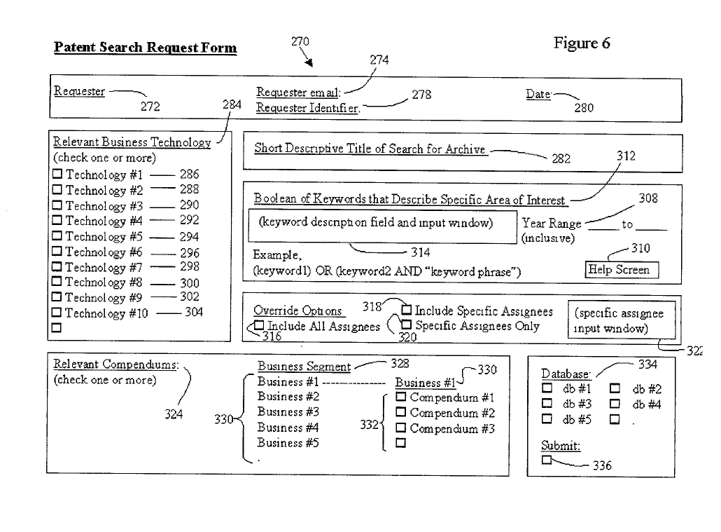

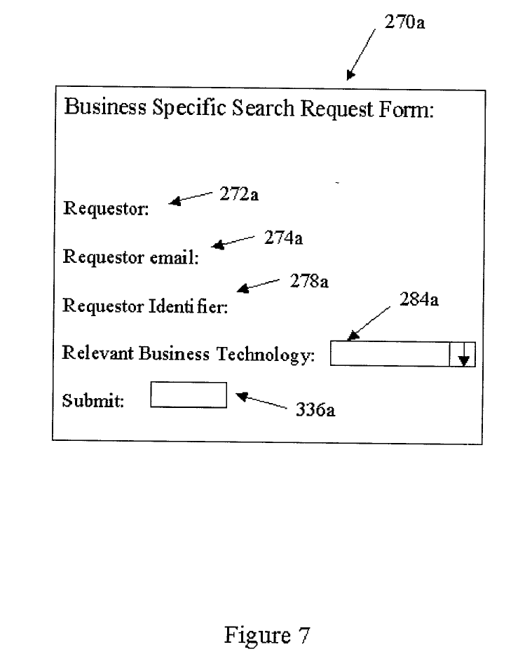

FIG. 6 is an exemplary embodiment of a pre-defined generic patent search request form 270 used by the user through a pull down menu. A requester 272 enters an e-mail address 274, a requester identifier (such as a telephone number or password) 278 and a date 280 on which a request is submitted. Requester 272 also enters a short descriptive title of the search for archive 282, checks one or more business technology selection boxes 284 out of Technology #1 286, Technology #2 288, Technology #3 290 Technology #4 292, Technology #5 294, Technology #6 296, Technology #7 298, Technology #8 300, Technology #9 302, and Technology #10 304. By way of example, Technology #1 through #10 for the electrical distribution and control business could be; Circuit Breakers, Control Products, Equipment, Medium Voltage, Meters, Motors, Power Delivery, Power Management, Process Automation, and Drive Systems, respectively. Other technology identifiers could be used as appropriate for another particular business. This selection facilitates narrowing of the search request and focuses only on relevant portions of database 18 for searching issued patents that reside thereon. The requester is then prompted for Boolean operators that define the logical relationship between various specific areas of interest 312 through an input window 314. The requester uses logical operators such as “OR”, “AND”, and “NOT” with pre-determined keywords and includes a year range 308 to finalize the request. In an alternate embodiment, a help screen option 310 is available which provides the requester 272 with additional information to assist in the use of logical operators. Requester 272 also checks an appropriate box to override options 316, 318, and 320. For example, where “Include All Assignees” 316 is selected, the assignees listed in competitor assignees 362 (shown in FIG. 7, and also depicted by competitor assignees 160 in FIG. 4) are disregarded and all available assignees 130 in database 18 meeting the other search criteria within request form 270 are included. Where “Include Specific Assignees” 318 is selected, the listed assignees 322 are “OR'd” with the competitor assignees 362 (160 in FIG. 4) to provide an aggregate of assignees. Where “Specific Assignees Only” 320 is selected, the competitor assignees 362 (160 in FIG. 4) are disregarded and only the specific assignees listed 322 are included. Requester 272 then completes Relevant Compendiums 324 with the help of pull down menus for each Business Segment entity 328. For example, in a given industry there may be multiple business entities 330, and each business entity may have multiple patent compendiums 332 relating to specific products or technologies within that entity. By way of example, for the electrical distribution and control industry, Business #1 through #5 (shown in FIG. 6 under Business Segment 328) could be Components, Motors, Meters, Control Products, and Process Automation, respectively. By further example, the compendium list of Compendium #1 through #3 for Business #1, could be Circuit Breaker, Contactor, and Relay, respectively. Other business and compendium identifiers could be used as appropriate for another particular business. Similar compendium lists could be available for Business #2 through #5 and accessible by way of pull down menus. The patent compendiums are stored in expert database 20. Requester 272 then selects the particular databases 334 for conducting the patent search. By way of example, databases (db's) #1 through #5 (shown in FIG. 6 under Database 334) could be US Patents, EP Patents, WO Patents, JPO Patents, or a proprietary database such as DERWENT™ Records, respectively, or a combination thereof. Other databases could be used as appropriate for the task. Centralized database 18 comprises the aggregate of selected databases 334. The requester submits 336 the search request to server system 12 through a client system 14 (shown in FIG. 1). Alternatively, the submit 336 function may be performed by sending the request form 270 to a server-accessible email address or URL address.

FIG. 7 is an exemplary embodiment of a business-specific search request form 270a used by a user who is interested in receiving frequent updates on newly issued patents pertaining to a specific business technology. The requester 272a enters an email address 274a and a requester identifier (such as a telephone number or password) 278a. The requestor 272a then identifies a business-specific technology 284a for which results are desired. An optional pull down menu may be employed for listing and selecting an available business-specific technology 284a with associated search strategy as provided by the expert database 20. Associated search strategies for each available business-specific technology 284a are created by business experts and reside in expert database 20. The contents of expert database 20 are similar to that described above and include technology folders 150. Business experts access the expert database 20 by an appropriate requestor identification 272a and requester identifier 278a that are recognized by the PSMS as providing access authorization. Additional information provided by the business expert is the frequency 500a, shown in FIG. 4, at which the business-specific patent searches are conducted, such as for example, once a month, week or day. The requester submits, or sends, 336a the business-specific search request to server system 12 through a client systems 14 (shown in FIG. 1). Recorded information matching the search request criteria is returned to the requester via the requestor's email address 274a, 274b at periodic intervals of time as defined by 500a, 500b.

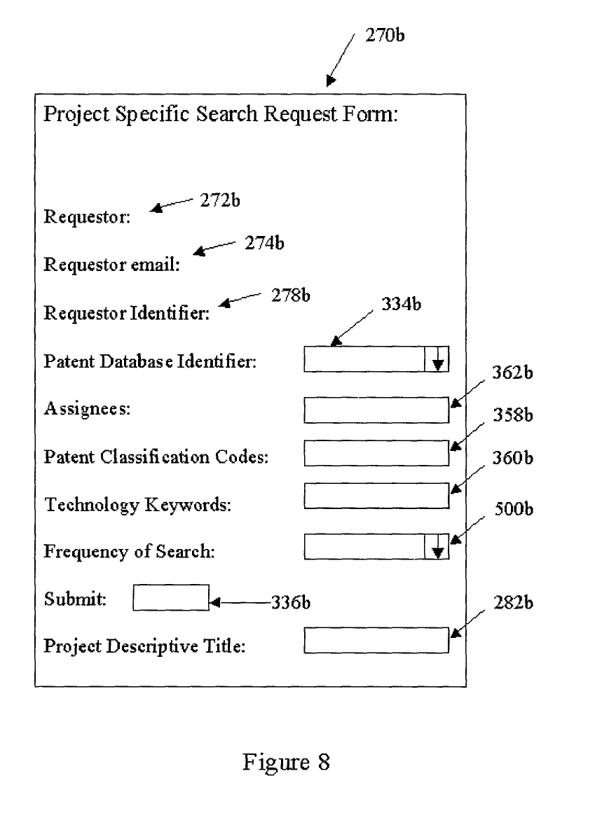

FIG. 8 is an exemplary embodiment of a project-specific search request form 270b used by a user who is interested in receiving frequent updates on newly issued patents pertaining to a specific project technology. The requestor 272b enters an email address 274b and a user identifier (such as a telephone number or password) 278b. The requester 272b also enters a project descriptive title 282b and search criteria specific to the respective project that may include, but is not limited to, patent database identifiers 334b, patent classification codes 358b, a Boolean string of technology keywords 360b, and competitor assignees 362b. The requester 272b also enters a search frequency 500b, such as for example, once a month, week or day, and which may be entered via a pull down menu. The requester submits, or sends, 336b the project-specific search request to server system 12 through a client systems 14 (shown in FIG. 1). Recorded information matching the search request criteria is returned to the requester via the requestor's email address 274a, 274b at periodic intervals of time as defined by 500a, 500b.

Components in FIGS. 7 and 8 that serve a similar purpose as components in FIG. 6 are identified by using the same reference numerals except with the addition of a letter suffix.

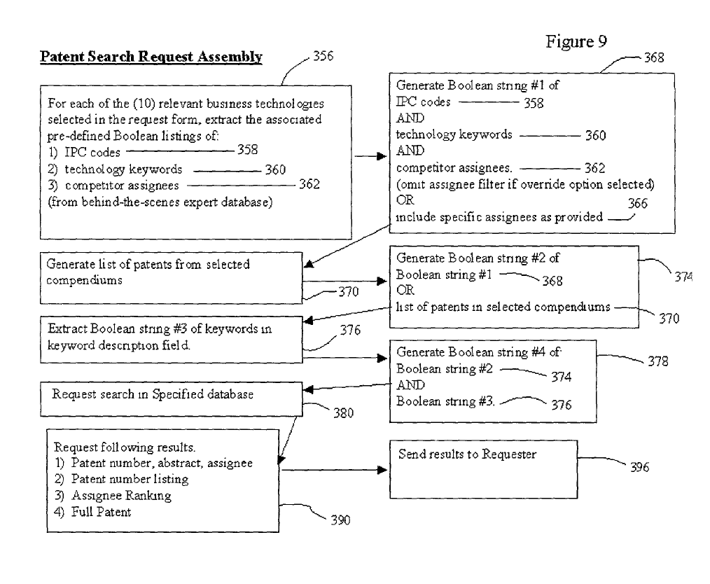

FIG. 9 is an exemplary embodiment of a Boolean Logic Search process utilized by server system 12 upon receiving a request form 270, 270a, or 270b from requester 272, 272a, or 272b (shown in FIGS. 6, 7 and 8). FIG. 9 is presented as an exemplary embodiment only, and where elements are not presented or described in FIG. 6, 7 or 8, those elements have a null effect with respect to the discussion of FIG. 9. For each of the relevant business technologies 284, 284a (shown in FIGS. 6 and 7) selected by requester 272, 272a on request form 270, 270a, system 10 extracts 356 from expert database 20 an associated pre-defined Boolean listing of IPC codes 358, Technology Keywords 360, and competitor assignees 362 (technology folder 150 shown in FIG. 4). The pre-defined Boolean listing is created by one or more business experts and is an important part of the present invention as it serves to appropriately tailor the business-specific search strategy for a particular technology within a particular business. By utilizing such an expert system, many individuals can benefit from the knowledge of a few experts. With respect to project-specific search strategies identified by the project descriptive title 282b on request form 270b, system 10 utilizes the IPC codes 358b, technology keywords 360b, and competitor assignees 362b identified on request form 270b in place of the pre-defined Boolean listing 356 in expert database 20. As shown, Logical Operator “AND” is used to generate Boolean string #1 368. System 10 generates Boolean string #1 368, of IPC codes 358, 358b, technology keywords 360, 360b and competitor assignees 362, 362b. Depending on the selection of override options 316, 318 and 320 (shown in FIG. 6), logical operator “OR” is employed to appropriately include or exclude 366 the competitor assignees 160 (shown in FIG. 4) and specific assignees 318 listed in specific assignee input window 322 (shown in FIG. 6) from the patent search strategy. Based on Boolean string #1 368, server system 10 accesses expert database 20 and generates a list of patents from selected Compendiums 370 (patent compendiums 332 and 166 shown in FIGS. 6 and 4, respectively). Boolean string #2 374 is generated based on Boolean string #1 368, and the list of patents in selected Compendiums 370 by using a logical operator “OR”. Subsequently, Boolean string #3 of keywords 376 is extracted from keyword description field 314 from request form 270 (shown in FIG. 6). Boolean string #4 is generated 378 based on Boolean string #2 374 and Boolean string #3 376 by using a logical operator “AND”. The request is then sent 380 to search identified patent databases 334, 334b in database 18 requesting 390 results organized in several different categories. While only one arrangement of results 390 is shown in FIG. 7, it will be appreciated that any arrangement of results may be established, and the results format may even be user defined. A message 396 is sent to the requester indicating that the search results will be sent to requester 272, 272a, 272b within one week from the request date 280 (shown in FIG. 6), or at the specified frequency 500a, 500b. In another embodiment, requester 272, 272a, 272b downloads the results instantaneously on the user interface and prints results on a remote or an attached printer.

As can be seen from the discussions relating to FIGS. 6, 7, 8 and 9, the step of retrieving pre-determined search request criteria from an expert database and combining it with the search request criteria from a user is optional, that is, where a business-specific search request form 270a (FIG. 7) is submitted, the PSMS 10 does access the expert database 20 via a selection of a relevant business technology 284a, and where a project-specific search request form 270b (FIG. 8) is submitted, the PSMS 10 does not access the expert database 20. Where a patent search request form 270 (FIG. 6) is submitted, the PSMS 10 does access the expert database 20 via a selection of one or more relevant business technologies 284.

Where a business-specific search request form 270a is submitted, the PSMS 10 retrieves pre-determined search request criteria, via a selection of a relevant business technology 284a, from expert database 20 and combines it with the user search request criteria 272a, 274a, 278a, thereby providing the PSMS 10 with adequate information of what to search and where to send the results notification 600 shown in FIG. 11. Where a project-specific search request form 270b is submitted, the PSMS 10 does not retrieve pre-determined search request criteria from expert database 20, but instead generates a Boolean string of user search request criteria, such as for example, IPC codes 358b, technology keywords 360b, and assignees 362b, acts upon this information in accordance with the steps of FIG. 5, and then sends the results notification 600 shown in FIG. 11 to the requestor as provided by user search request criteria 272b, 274b, 278b.

Thus, while the step of retrieving pre-determined search request criteria from an expert database and combining it with the search request criteria from a user is optional, it is a well defined process that operates according to the type of search request form submitted by the user.

FIG. 10 is an exemplary embodiment of a results-folder structure 520 for retaining information relating to business-specific 530 and project-specific 540 patent searches. The business-specific 530 and project-specific 540 folders include file header information 528, 538 for identifying the relevant business-specific or project-specific searches (such as identified by 284a, 282b in FIGS. 7 and 8), delta-set folders 522, 532 for retaining the latest search results since the completion of the last search, accumulation-set folders 524, 534 for retaining an accumulation of search results, and search strategy folders 526, 536 for retaining the business-specific and project-specific search strategies. While only one set of business-specific 530 and project-specific 540 patent search folders are illustrated, one skilled in the art will readily appreciate that the results-folder structure 520 can comprise a plurality of such business and project-specific folders 530, 540. Results-folder structure 520 resides on database 18 and is accessible by users through client systems 14. On successive searches at predefined intervals 500a, 500b, the contents of the delta-set 522, 532 folders are transferred to the accumulation-set 524, 534 folders and the delta-set 522, 532 folders are repopulated with the search results of the most recent database searches. Thus, the delta-set 522, 532 folders retain only the most recent set of search results since the prior search was conducted, and the accumulation-set 524, 534 folders contain an aggregate of all the delta-set 522, 532 results since the initiation of the respective database searches. The requester who is identified in the field 272a, 272b, shown in FIGS. 7 and 8, is notified when the content of the delta-set 522, 532 has been updated, and is provided with access to the delta-set 522, 532 and accumulation-set 524, 534 folders for viewing the search results.

Patent search strategies 526 relating to the business-specific 530 results folders are created by authorized business experts who populate expert database 20 with the appropriate information as described in conjunction with FIG. 4. Authorized user access to expert database 20 is provided through client systems 14. The PSMS 10 verifies user authorization by comparing a username/password combination (such as for example the requestor email 274a and requestor identifier 278a shown on form 270a) against a master list retained by or accessible to the PSMS 10. The PSMS 10 accesses the expert database 20 at pre-defined intervals as described in conjunction with FIG. 5, runs the query as described in FIG. 5, and populates the business-specific delta-set 522 with information pertaining to newly issued patents that match the respective search criteria. The delta-set 522 and accumulation-set 524 folders are updated on successive periodic searches as outlined above.

Patent search strategies 536 relating to the project-specific 540 results folders are created by any authorized user who submits a search request via the project-specific search request form 270b as described in conjunction with FIG. 8. Authorized user access to the PSMS 10 is provided through client systems 14. The PSMS 10 verifies user authorization by comparing a username/password combination (such as for example the requestor email 274b and requestor identifier 278b shown on form 270b) against a master list retained by or accessible to the PSMS 10. The PSMS 10 receives the search criteria according to the contents of form 270b in FIG. 8 and assembles the patent search request according to the process outlined in FIG. 9 at pre-defined intervals as described in conjunction with FIG. 5, runs the query as described in FIG. 5, and populates the project-specific delta-set 532 with information pertaining to newly issued patents that match the respective search criteria. The delta-set 532 and accumulation-set 534 folders are updated on successive periodic searches as outlined above. In an alternate embodiment, the PSMS 10 retains the search strategy 536 as provided and described in FIG. 9, thereby eliminating the need to resubmit the search strategy on every successive run.

The utilization of two types of delta-set 522, 532 and accumulation-set 524, 534 folders allows for the retention of business-specific 530 and project-specific 540 search results. The business-specific 530 results folders are intended to provide information on newly issued patents relating to general business-related technologies, while the project-specific 540 results folders are intended to provide information on newly issued patents relating to narrower project-related technologies. Access to the business-specific 530 and project-specific 540 search strategies and results folders is controlled by the PSMS 10 via a username/password combination (such as for example via the requestor email 274a and requestor identifier 278a shown on form 270a) in a similar manner as described above. Regarding the business-specific 530 search strategies and results folders, only the authorized business expert and those subsequently authorized by the business expert have read and write capability with respect to the search strategies 526. However, any authorized user of the PSMS 10 has read capability with respect to the business-specific 530 results folders 522, 524. Regarding the project-specific 540 search strategies and results folders, only the authorized user who submits the project-specific search request form 270b and those subsequently authorized by the respective requester 272b have read and write capability with respect to both the search strategies 536 and the results folders 532, 534.

In an alternate embodiment, the contents of accumulation-set 524, 534 results folders are such that no entry is older than a pre-defined age, such as for example one year, as measured by the record's issue or publication date. Upon the completion of a periodic database search, the PSMS 10 automatically purges the accumulation-set 524, 534 results folders of any record that is older than the predefined one year age. Additionally, all project-specific 540 search folders (that is, delta-set 532, accumulation-set 534, search strategy 536, and file header info 538) relating to a particular project-specific search request 270b are deleted at a pre-defined age, such as for example six months, after the project-specific search request form 270b is submitted unless the requester reaffirms that they should not be deleted. The PSMS 10 prompts the requestor prior to an automatic deletion, such as for example 30 days prior to deletion, for a reaffirmation. If the requester reaffirms that the respective project-specific 540 search folders should not be deleted, then they remain active for an additional pre-defined term, such as for example six months. The reaffirmation process is repeated until the requestor personally deletes the respective files, or does not reaffirm. In another alternate embodiment, the user can apply an over-ride option to prevent a patent or sub-set of patents from being purged or deleted.

FIG. 11 is an exemplary embodiment of a results notification 600 generated by the PSMS 10 after the completion of a regularly scheduled database search, whereby the requestor is notified that a specified delta-set 522, 532 has been updated with new entries. A specified delta-set 522, 532 is any delta-set 522, 532 that is associated with, or specified by, a request 270a, 270b submitted by the requester. The request 270a, 270b serves as a request to the PSMS 10 to have the requestor's name added to an email distribution list that is associated with a given patent search results-folder 520, business-specific 530 or project-specific 540. By providing a user of the PSMS 10 with the capability of including their own name to an email distribution list for receiving patent search updates, the need to have a separate system administrator is avoided. The email distribution list is maintained by the PSMS 10 via mail server 32 on server 12. The results notification 600 may be sent by email, fax, voicemail, wireless communication, or other equally capable means of communicating information. However, for simplicity, the results notification 600 will be discussed in terms of an email system. The header information of the results notification 600, or email, includes a recipient identifier 602, a sender identifier 604, a subject identifier 606, and a date identifier 608. The body of the results notification 600 includes a listing of patent numbers 610 that match the respective search criteria and were newly issued since the last periodic search, a listing of respective patent titles 612, and links 614 to the respective patents. The links 614 are embedded internet addresses, commonly called URL's (Uniform Resource Locator), that provide the identified recipient 602 with access to a copy of a listed patent 610, 612 stored on database 18 for further review. Users access copies of listed patents 610, 612 through client systems 14. When the patent search request 270a, 270b originates from a project-specific search request 270b, the body of the results notification 600 also includes a reaffirmation request 616. The reaffirmation request 616 requires a Yes/No response and functions as described above in conjunction with FIG. 10.

In an alternative embodiment, the PSMS 10 provides the reaffirmation request 616 in another communication, such as email, that is separate from the results notification 600. The alternative reaffirmation request 616, which operates as described above in conjunction with FIG. 10, is sent by the PSMS 10 to the requester of a project-specific search request 270b prior to an automatic deletion, such as for example 30 days prior to deletion. If the requester reaffirms that the respective project-specific 540 search folders should not be deleted, then they remain active for an additional six months. The reaffirmation process is repeated until the requestor personally deletes the respective files, does not respond to the reaffirmation request, or selects the “No” option with respect to the reaffirmation request 616.

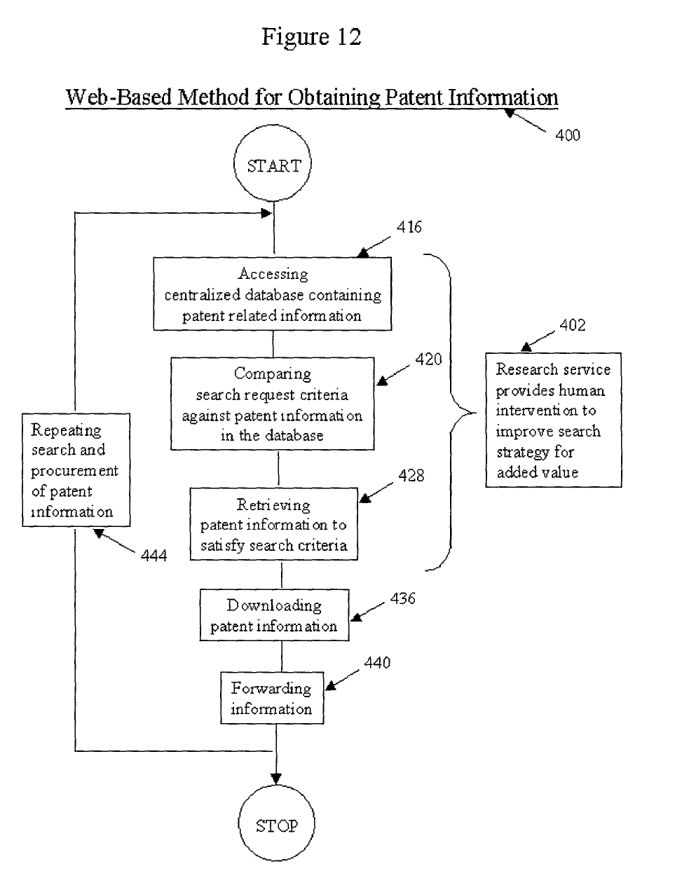

An alternative embodiment of the present invention 400 is shown in FIG. 12, where a research service 402 provides human intervention to improve the search strategy provided by request form 270, 270a, 270b for added value. Examples of such research services 402 includes, for example, The DIALOG™ Corporation, DERWENT™, NERAC™, Inc., TELTECH™ Resource Network Corporation, and Aurigin™ Systems, Inc. While the process steps of accessing 216, comparing 220, and retrieving 228 shown in FIG. 5, can be handled automatically in the accessing and processing components 72 and 76 (shown in FIG. 3) by patent search engines, not all requesters 272, 272a, 272b (shown in FIGS. 6, 7, 8) are familiar with the preferred search methodologies. Thus, professional researchers from research services 402 can add value to the user request form 270, 270a, 270b (shown in FIG. 6, 7, 8) by intervening between the request form 270, 270a, 270b and the centralized database of patents 18, and enhancing the search strategy. Such enhancements may include, for example, the inclusion of root expanders, the inclusion of keyword proximity operators, rearrangement of keywords, the inclusion of assignee codes, and modification of the Boolean logical operators. Intervention by the research service 402 is accomplished by system 10 forwarding the compiled search strategy from request form 270, 270a, 270b to research service 402, which then coordinates the activities of accessing 416, comparing 420 and retrieving 428. Research service 402 then directs the downloaded patent information 436 to be forwarded to system 10 for subsequent forwarding 440 to requester 272, 272a, 272b. System 10 stores the requested information in a results-folder structure, as shown in FIG. 10, and provides results notification, as shown in FIG. 11, to the plurality of users requesting the same. Whether the preferred embodiment or alternate embodiment of the present invention is employed, the requester 272, 272a, 272b interacts with the patent search management system 10 in the same way by submitting requests via request form 270, 270a, 270b to system 10 and receiving 436 downloaded patent information directly from system 10. Tracking component 66 (shown in FIG. 3) of system 10 logs in the status of the request before the results are forwarded to the requester.

In another alternate embodiment, this process could be used for case law research, where an expert database could include for example specific citation indices, specific plaintiffs or defendants, and specific legal keywords. The grouping of Technology #1 through #10 could be replaced for example by a grouping of legal disciplines, and the grouping of Business #1 through #5 could be replaced for example by a grouping of parties to a law suit. Within each “party to a law suit” group, the grouping of Compendium #1 through #3 could be replaced for example by compendiums of law suits that the particular party has been associated with. Based on the preferred embodiment and foregoing example, other applications falling within the spirit and scope of the present invention will be readily recognizable to one skilled in the art, such as for example, database research relating to human resources, market development, mortgage, stock, and bond trends, and international affairs.

In yet another alternate embodiment, this process could be used for financial analysis research, where an expert database could include for example gross sales or net profit indices, specific business entities, contribution margin or operating margin indices, and specific financial keywords. The grouping of Technology #1 through #10 could be replaced for example by a grouping of product or service offerings, and the Business #1 through #5 could be replaced for example by a grouping of business market segments. Within each “business market segment” group, the grouping of Compendium #1 through #3 could be replaced for example by compendiums of annual reports that are associated with a particular business market segment.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium (embodied in the form of a propagated signal propagated over a propagation medium, with the signal containing the instructions embodied therein), such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While this invention has been described with reference to various embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention include all embodiments falling within the scope of the appended claims.

1. A method for facilitating selection of recorded information using a web-based system including a server system and at least one client system connected to the server system via a network, said method comprising the steps of:
receiving search request criteria from a user;
optionally retrieving pre-determined search request criteria from an expert database and combining it with the search request criteria from a user;
accessing a centralized database of recorded information maintained including identifiers associated with each record of the recorded information;
comparing the search request criteria from a user against the recorded information maintained in the centralized database using the identifiers;
retrieving the recorded information to satisfy the search request criteria from a user;
downloading the recorded information to a first storage location; and
repeating the steps to search and procure recorded information.

2. A method according to claim 1 wherein said step of accessing a centralized database further comprises the step of accessing a centralized database of patent information.

3. A method according to claim 1 wherein said step of accessing a centralized database further comprises the step of accessing a centralized database of case law information.

4. A method according to claim 1 wherein said step of accessing a centralized database further comprises the step of accessing a centralized database of pertinent information.

5. A method according to claim 1 wherein said step of receiving search request criteria from a user further comprises the step of receiving at least one of a Requester's Name, a Requester's e-mail Address, a Requester's Telephone Number, a Date on which a request is being submitted, a selection of a Relevant Business Technology out of various business technologies, a Short Descriptive Title of search for Archive, Boolean of Keywords that Describe Specific Area of Interest, a selection of Override Options, identification of Relevant Compendiums and a selection of a specific Database.

6. A method according to claim 1 wherein said step of receiving search request criteria from a user further comprises the step of selecting information through pull down menu choices for each search criteria.

7. A method according to claim 1 wherein said step of retrieving predetermined search request criteria from an expert database further comprises the step of defining a logical relationship among search terms defining a Boolean logic string request.

8. A method according to claim 7 wherein said step of defining logical relationship among search terms further comprises the step of defining a logical relationship at least between two of IPC Code, Technology Keywords, Competitor Assignees, an Item Number, a Name of the business, and an originator name.

9. A method according to claim 1 wherein said step of comparing the search request criteria against the recorded information maintained in the centralized database using the identifiers further comprises the step of comparing at least one of an IPC Code, Technology Keywords, Competitor Assignees, an Item Number, a Name of the business, and an originator name.

10. A method according to claim 1 wherein said step of comparing the search request criteria against the recorded information maintained in the centralized database using the identifiers further comprises the step of identifying the item by at least one of an IPC Code, Technology Keywords, Competitor Assignees, an Item Number, a Name of the business, and an originator name.

11. A method according to claim 1 wherein said step of comparing the search request criteria against the recorded information maintained in the centralized database using the identifiers further comprises the step of identifying the item by at least one relevant business technology.

12. A method according to claim 1 wherein said step of retrieving the recorded information further comprises the step of selecting at least one item from the database which meets the search criteria received from the user.

13. A method according to claim 1 wherein said step of retrieving the recorded information further comprises the step of selecting at least one case law from the database which meets the search criteria received from the user.

14. A method according to claim 1 wherein said step of retrieving the recorded information further comprises the step of retrieving patent information including at least one of a patent number, an abstract, a name of an assignee, a ranking of the assignee, an IPC code, an inventor's full name, an inventor's address, a portion of the patent text, and a patent illustration.

15. A method according to claim 1 wherein said step of downloading the recorded information further comprises the steps of:
displaying the recorded information on a graphical user interface; and
printing the recorded information on a printer.

16. A method according to claim 1 further comprising the steps of:
protecting the centralized database from access by unauthorized individuals; and
placing an authenticated request to search on-line to obtain recorded information.

17. A method according to claim 1 wherein said step of receiving search request criteria from a user further comprises the step of receiving search request criteria from the user via a graphical user interface.

18. A method according to claim 1 wherein said step of receiving search request criteria from a user further comprises the step of receiving search request criteria through a voice activated device.

19. A method according to claim 1 further comprising the step of utilizing a research service that provides human intervention to improve the search strategy.

20. A method for facilitating selection of recorded information using a web-based system including a server system and at least one client system connected to the server system via a network, said method comprising the steps of:
receiving search request criteria from a user;
optionally retrieving pre-determined search request criteria from an expert database and combining it with the search request criteria from a user;
accessing a centralized database of recorded information maintained including identifiers associated with each record of the recorded information;
comparing the search request criteria from a user against the recorded information maintained in the centralized database using the identifiers;
retrieving the recorded information to satisfy the search request criteria from a user;
downloading the recorded information to a first storage location;
sending the recorded information to the user; and
repeating the steps to search and procure recorded information.

21. A method according to claim 20 wherein said step of sending the recorded information comprises sending the recorded information via an email message.

22. A method according to claim 21 wherein said step of sending the recorded information via an email message further comprises the step of providing an electronic link between the recorded information in the email message and the recorded information in the centralized database of recorded information.

23. A method according to claim 20 wherein said step of downloading the recorded information further comprises the step of transferring the recorded information in the first storage location to a second storage location before downloading the recorded information to the first storage location.

24. A method according to claim 23 wherein said step of transferring the recorded information to a second storage location further comprises the step of deleting that recorded information in the second storage location that has been publicly available for more than a pre-defined length of time.

25. A method according to claim 20 wherein said step of repeating the search and procurement of recorded information further comprises the step of repeating the search and procurement of recorded information at predefined intervals of time.

26. A method according to claim 25 wherein said step of repeating the search and procurement of recorded information further comprises the step of terminating the repeating cycle after a pre-defined number of cycles.

27. A method according to claim 26 wherein said step of terminating the repeating cycle further comprises the step of canceling the terminating step.

28. A method according to claim 20 further comprising the step of recording the search request criteria from a user.

29. A method according to claim 28 further comprising the step of editing the recorded search request criteria from a user.

30. A web-based system for facilitating selection of recorded information, said system comprising:
a client system comprising a browser;
a centralized database comprising recorded information wherein the recorded information is linked to at least one identifier:
a server system connected to said client system and said centralized database, said server system configured to:
receive search request criteria from a user;
optionally retrieve pre-determined search request criteria from an expert database and combine it with the user search request criteria;
access a centralized database of recorded information maintained including identifiers associated with each record of the recorded information;
compare the user search request criteria against the recorded information maintained in the centralized database using the identifiers;
retrieve the recorded information to satisfy the user search request criteria;
download the recorded information to a first storage location; and
repeat the search and procurement of recorded information.

31. A system according to claim 30 wherein said server system further configured to access a centralized database of patent information.

32. A system according to claim 30 wherein said server system further configured to access a centralized database of case law information.

33. A system according to claim 30 wherein said server system further configured to receive at least one of a Requester's Name, a Requester's email Address, a Requester's Telephone Number, a Date on which a request is being submitted, a selection of a Relevant Business Technology out of various business technologies, a Short Descriptive Title of search for Archive, Boolean of Keywords that Describe Specific Area of Interest, a selection of Override Options, identification of Relevant Compendiums and a selection of a specific Database.

34. A system according to claim 30 wherein said server system further configured to receive search request criteria from a user through pull down menu choices for at least one search request criteria.

35. A system according to claim 30 wherein said server system further configured to search criteria entered by the user against the centralized database of recorded information.

36. A system according to claim 33 wherein said server system further configured to analyze received search request criteria from a user to identify specific recorded information.

37. A system according to claim 33 wherein said server system further configured to compare the search request criteria against the recorded information maintained in the centralized database using the identifiers.

38. A system according to claim 31 wherein said server system further configured to record information including at least one of a patent number, a brief description of the patent, relevant business technology or technologies where the issued patent has relevance, a name of the assignee, an IPC code as it relates to each patent, technology key words describing the patented technology, an abstract, and other pertinent information relating to each patent number.

39. A system according to claim 33 wherein said server system further configured with patent information that includes a patent number assigned to a unique identifier and cross referencing relevant information relating to each patent to the patent number.

40. A system according to claim 33 wherein said server system further configured with pull down menu choices for each category of received search request criteria from a user.

41. A system according to claim 33 wherein said server system further configured to compare at least one of an IPC Code, Technology Keywords, Competitor Assignees, an Item Number, a Name of the business, and an Inventor name.

42. A system according to claim 33 wherein said server system further configured to define a logical relationship among search terms often defined as Boolean Logic.

43. A system according to claim 42 wherein said server system configured to define a logical relationship is further configured to define a logical relationship between at least two of an IPC Code, Technology Keywords, Competitor Assignees, an Item Number, a Name of the business, and an Inventor name.

44. A system according to claim 41 wherein said server system further configured to identify the patent by at least one of an IPC Code, Technology Keywords, Competitor Assignees, an Item Number, a Name of the business, and an Inventor name.

45. A system according to claim 41 wherein said server system further configured to identify a patent by a relevant business technology.

46. A system according to claim 33 wherein said server system further configured to select at least one patent from the database which meets the search criteria received from the user.

47. A system according to claim 33 wherein said server system further configured to retrieve recorded information including at least one of a patent number, an abstract, a name of an assignee, a ranking of the assignee, an IPC code, an inventor's full name, an inventor's address, a portion of the patent text, and a patent illustration.

48. A system according to claim 33 wherein said server system further configured to:
display the recorded information on a graphical user interface; and
print the recorded information on a printer.

49. A system according to claim 33 wherein said server system further configured to:
protect the centralized database from access by unauthorized individuals; and
place an authenticated request to search on-line to obtain recorded information.

50. A system according to claim 33 wherein said server system further configured to receive search criteria from the user via a graphical user interface.

51. A system according to claim 33 wherein said server system further configured to receive search criteria through a voice activated device.

52. A system according to claim 33 wherein said server system further configured to generate a report in a pre-determined format.

53. A system according to claim 33 wherein said server system further configured to accept search request criteria after the user has been authenticated against pre-determined criteria.

54. A system according to claim 33 wherein said server system further configured to display recorded information on a user's graphical user interface and print the recorded information on a printer.

55. A system according to claim 33 wherein said server system further configured to protect the centralized database from access by unauthorized individuals.

56. A system according to claim 34 wherein said client system configured as a server system for a network of customer devices.

57. A system according to claim 34 wherein said server system and said device are connected via a network.

58. A system according to claim 55 wherein said network is one of a wide area network, a local area network and the Internet.

59. A web-based system for facilitating selection of recorded information, said system comprising:
a client system comprising a browser;
a centralized database comprising recorded information wherein the recorded information is linked to at least one identifier:
a server system connected to said client system and said centralized database, said server system configured to:
receive search request criteria from a user;
optionally retrieve pre-determined search request criteria from an expert database and combine it with the user search request criteria;
access a centralized database of recorded information maintained including identifiers associated with each record of the recorded information;
compare the user search request criteria against the recorded information maintained in the centralized database using the identifiers;
retrieve the recorded information to satisfy the user search request criteria;
download the recorded information to a first storage location;
send the recorded information to the user; and
repeat the search and procurement of recorded information.

60. A system according to claim 59 wherein said server system configured to electronically send the recorded information is further configured to send the recorded information via an email message.

61. A system according to 60 wherein said server system is further configured to provide an electronic link between the recorded information in the email message and the recorded information in the centralized database of recorded information.

62. A system according to claim 59 wherein said server system configured to download the recorded information is further configured to transfer the recorded information in the first storage location to a second storage location before the recorded information is downloaded to the first storage location.

63. A system according to claim 62 wherein said server system configured to transfer the recorded information to a second storage location is further configured to delete that recorded information in the second storage location that has been publicly available for more than a pre-defined length of time.

64. A system according to claim 59 wherein said server system configured to repeat the search and procurement of recorded information is further configured to repeat the search and procurement of recorded information at pre-defined intervals of time.

65. A system according to claim 64 wherein said server system configured to repeat the search and procurement of recorded information is further configured to terminate the repeat cycle after a pre-defined number of cycles.

66. A system according to claim 65 wherein said server system configured to terminate the repeat cycle is further configured to cancel the termination of the repeat cycle.

67. A system according to claim 59 wherein said server system is further configured to record the search request criteria from a user.

68. A system according to claim 67 wherein said server system is further configured to edit the recorded search request criteria from a user.

69. A method for facilitating selection of recorded information using a web-based system including a server system and at least one client system connected to the server system via a network, said method comprising the steps of:
receiving search request criteria from a user;
optionally retrieving pre-determined search request criteria from an expert database and combining it with the search request criteria from a user;
accessing a centralized database of recorded information maintained including identifiers associated with each record of the recorded information;
comparing the search request criteria from a user against the recorded information maintained in the centralized database using the identifiers;
retrieving the recorded information to satisfy the search request criteria from a user;
downloading the recorded information to a first storage location; and
sending the recorded information to the user.

70. A web-based system for facilitating selection of recorded information, said system comprising:
a client system comprising a browser;
a centralized database comprising recorded information wherein the recorded information is linked to at least one identifier:
a server system connected to said client system and said centralized database, said server system configured to:
receive search request criteria from a user;
optionally retrieve pre-determined search request criteria from an expert database and combine it with the user search request criteria;
access a centralized database of recorded information maintained including identifiers associated with each record of the recorded information;
compare the user search request criteria against the recorded information maintained in the centralized database using the identifiers;
retrieve the recorded information to satisfy the user search request criteria;
download the recorded information to a first storage location; and
send the recorded information to the user.

71. A data signal propagated over a propagation medium, said data signal including logical data, said data having been logically arranged by a method comprising the steps of:
receiving search request criteria from a user;
optionally retrieving pre-determined search request criteria from an expert database and combining it with the search request criteria from a user;
accessing a centralized database of recorded information maintained including identifiers associated with each record of the recorded information;
comparing the search request criteria from a user against the recorded information maintained in the centralized database using the identifiers;
retrieving the recorded information to satisfy the search request criteria from a user;
downloading the recorded information to a first storage location; and
sending the recorded information to the user.

72. The data signal according to claim 71 wherein said data having been logically arranged by a method further comprising the step of repeating the steps to search and procure recorded information.
